(19) United States
(12) Patent Application Publication
(10) Pub. No.: US 2024/0067476 A1
(43) Pub. Date: Feb. 29, 2024

(54) MEDIUM THICKNESS DETECTION DEVICE

(71) Applicant: AVISION INC., Hsinchu (TW)

(72) Inventors: WEI CHIN CHENG, Zhubei City (TW); YU-LANG WANG, Jhubei City (TW)

(21) Appl. No.: 18/334,824

(22) Filed: Jun. 14, 2023

(30) Foreign Application Priority Data
Aug. 31, 2022 (TW) 111132883

(51) Int. Cl. B65H 7/20

(52) U.S. Cl. CPC B65H 7/20; B65H 2511/13; B65H 2515/70; B65H 2553/412; B65H 2557/31

(57) ABSTRACT

A medium thickness detection device includes: a light emitting element; a constant-current control circuit controlling, in a constant-current manner, the light emitting element to output light passing through a medium for an irradiation time; a light-receiving element receiving the light passing through the medium to obtain an analog signal; a receiver circuit receiving the analog signal; a maximum holding circuit holding a maximum of the analog signal; an analog-to-digital converter circuit reading the maximum of the analog signal and converting the maximum of the analog signal into a digital signal; a reset circuit resetting the maximum holding circuit; and a processor controlling operations of the constant-current control circuit, the reset circuit and the analog-to-digital converter circuit, and determining a thickness of the medium according to the digital signal when a specification of the medium is unknown.

### CROSS-REFERENCE TO RELATED APPLICATIONS

This application claims priority of No. 111132883 filed in Taiwan R.O.C. on Aug. 31, 2022 under 35 USC 119, the entire content of which is hereby incorporated by reference.

### FIELD OF THE INVENTION

This disclosure relates to a medium thickness detection device, and more particularly to a medium thickness detection device using transient light emitting and receiving to achieve the stable medium thickness detection.

### DESCRIPTION OF RELATED ART

At present, printers or multi-function peripherals are equipped with sheet size detectors for detecting sizes of sheets, so that the sheets with proper sizes can be selected and printed out. For the sheet thickness detection, a multi-feed sensor is mainly used for detecting multiple sheets being fed to prevent the paper jam. The thickness of the sheet can be detected in an ultrasonic manner, wherein a stably outputted ultrasonic wave penetrates through the sheet, and a penetrating wave is generated and received by an ultrasonic receiver. The thickness of the sheet can be determined according to the signal attenuation of the penetrating wave. Such the detection method has the thickness detecting precision and stability that are not high, and needs to be further improved in order to satisfy the progressing printing requirements (e.g., controlling of the printing parameters according to the thickness of the sheet).

### SUMMARY OF THE INVENTION

It is therefore an objective of this disclosure to provide a medium thickness detection device of achieving the stable medium thickness detection using transient light emitting and receiving, as well of achieving the self-learning thickness detection calibration for factory calibration or future maintenance calibration.

To achieve the above-identified objective, this disclosure provides a medium thickness detection device including: a light emitting element; a constant-current control circuit, which is electrically connected to the light emitting element, and controls, in a constant-current manner, the light emitting element to output light passing through a medium for an irradiation time; a light-receiving element receiving the light passing through the medium to obtain an analog signal; a receiver circuit being electrically connected to the light-receiving element, and receiving the analog signal; a maximum holding circuit being electrically connected to the receiver circuit, and holding a maximum of the analog signal; an analog-to-digital converter (ADC) circuit, which is electrically connected to the maximum holding circuit, reads the maximum of the analog signal, and converts the maximum of the analog signal into a digital signal; a reset circuit, which is electrically connected to the maximum holding circuit, and resets the maximum holding circuit; and a processor, which is electrically connected to the constant-current control circuit, the reset circuit and the analog-to-digital converter circuit, and controls operations of the constant-current control circuit, the reset circuit and the analog-to-digital converter circuit. The processor determines a thickness of the medium according to the digital signal when a specification of the medium is unknown.

With the above-mentioned embodiment, the medium thickness detection device can provide the stable and precise detection result. Furthermore, the error problem caused by the detection result due to the process variability of the light-receiving element of the photo sensor, for example, can be decreased by the learning mode. The precise detection result can be used to control the printing or other processing parameters more precisely, and enhance the printing or other effects.

In order to make the above-mentioned content of this disclosure more obvious and be easily understood, preferred embodiments will be described in detail as follows in conjunction with the accompanying drawings.

### BRIEF DESCRIPTION OF DRAWINGS

FIG. 1 is a block diagram showing a medium thickness detection device according to a preferred embodiment of this disclosure.

FIG. 2 shows an operation timing chart of the medium thickness detection device of FIG. 1 in a detecting mode.

FIG. 3 shows an operation timing chart of the medium thickness detection device of FIG. 1 in a learning mode.

FIG. 4 shows an operation flow chart of the medium thickness detection device of FIG. 1.

### DETAILED DESCRIPTION OF THE INVENTION

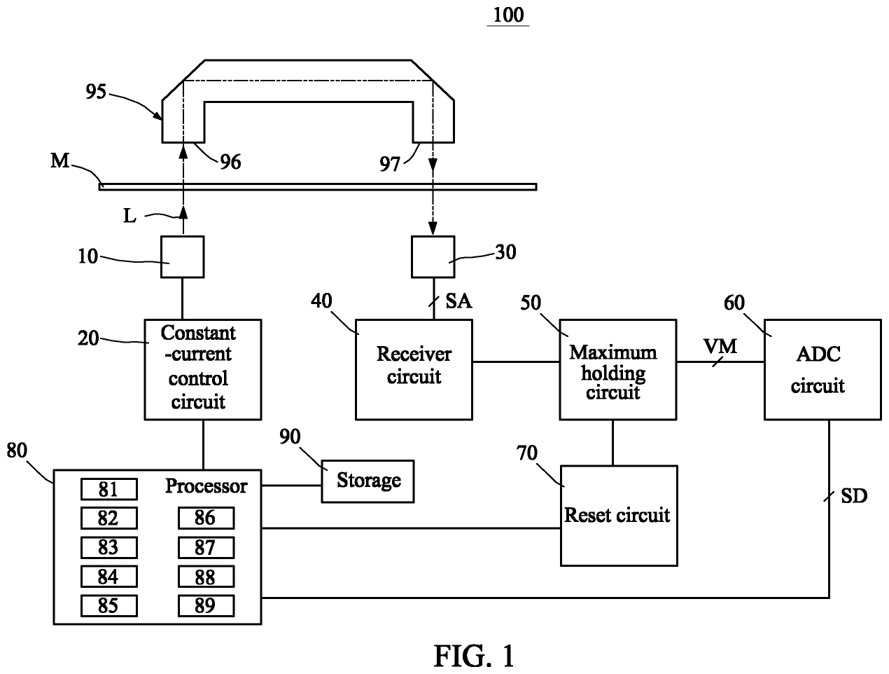

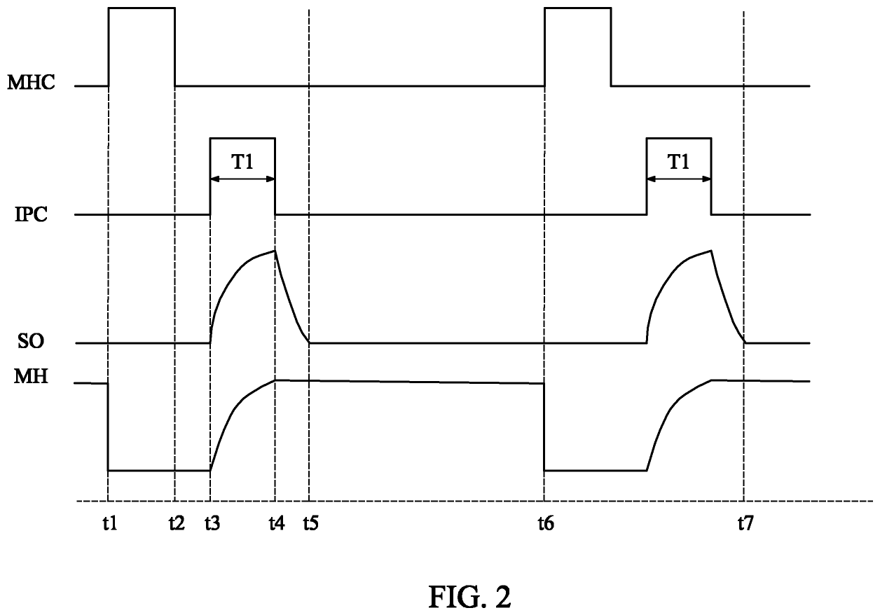

FIG. 1 is a block diagram showing a medium thickness detection device according to a preferred embodiment of this disclosure. FIG. 2 shows an operation timing chart of the medium thickness detection device of FIG. 1 in a detecting mode. Referring to FIGS. 1 and 2, this embodiment provides a medium thickness detection device 100 including a light emitting element 10, a constant-current control circuit 20, a light-receiving element 30, a receiver circuit 40, a maximum holding circuit 50, an analog-to-digital converter circuit 60, a reset circuit 70 and a processor 80. In one example, the processor 80 may include a resetting module 81, a holding module 82, a reader module 83, a delaying module 84, a repeating module 85, a determining module 86, a learning module 87, a selecting module 88 and a setting module 89. These modules may be implemented by firmware having programming codes or by hardware circuits.

In this embodiment, the constant-current control circuit 20 is electrically connected to the light emitting element 10, the receiver circuit 40 is electrically connected to the light-receiving element 30, the maximum holding circuit 50 is electrically connected to the receiver circuit 40, the analog-to-digital converter circuit 60 is electrically connected to the maximum holding circuit 50, the reset circuit 70 is electrically connected to the maximum holding circuit 50, and the processor 80 is electrically connected to the constant-current control circuit 20, the reset circuit 70 and the analog-to-digital converter circuit 60. In another embodiment, the processor 80 may also be electrically connected to the receiver circuit 40 and controls the receiver circuit 40 to perform receiving and resetting. The processor 80 has a detecting mode and a learning mode, and the detecting mode is firstly explained.

The constant-current control circuit 20 controls, in a constant-current manner, the light emitting element 10 to output light L passing or penetrating through a medium M continuously for an irradiation time T1. The light-receiving element 30 receives the light L passing through the medium M to obtain an analog signal SA. The receiver circuit 40 receives the analog signal SA. The maximum holding circuit 50 holds a maximum VM of the analog signal SA. The analog-to-digital converter circuit 60 reads the maximum VM of the analog signal SA, and converts the maximum VM of the analog signal SA into a digital signal SD. The reset circuit 70 resets the maximum holding circuit 50. In one example, the reset circuit 70 resets the maximum holding circuit 50 after the analog-to-digital converter circuit 60 has read the maximum VM of the analog signal SA and before the light emitting element 10 outputs the light L. The processor 80 controls operations of the constant-current control circuit 20, the reset circuit 70 and the analog-to-digital converter circuit 60. The processor 80 determines a thickness of the medium M according to the digital signal SD when the specification of the medium M is unknown (i.e., in a detecting mode).

In this embodiment, the light emitting element 10 is an infrared light emitter, the light-receiving element 30 is a photo transistor, but this disclosure is not restricted thereto. This disclosure mainly works according to transient properties of light emitting and receiving. When the light transmission rate of the medium M is high, the voltage of the light-receiving element 30 rises at a high speed. When the light transmission rate of the medium M is low, the voltage of the light-receiving element 30 rises at a low speed. A predetermined exposure time is given according to this relationship. The light-receiving element 30 generates two different voltages corresponding to two media, wherein the thickness of one of the media can be determined according to the voltage difference between the two voltages when the thickness of the other one of the media is known.

In the actual operation, the processor 80 performs the following operations in order. The resetting module 81 performs the operation (a) of controlling the reset circuit 70 to reset the maximum holding circuit 50; the holding module 82 performs the operation (b) of turning on the constant-current control circuit 20 to control the light emitting element 10 to continuously output the light L for the irradiation time T1, and then turning off the light emitting element 10 to let the maximum holding circuit 50 hold the maximum VM of the analog signal SA, and let the analog-to-digital converter circuit 60 generate the digital signal SD; and the reader module 83 performs the operation (c) of reading the digital signal SD through the analog-to-digital converter circuit 60. In one example, the maximum holding circuit 50 may be implemented by a diode and a capacitor. It is understandable that a medium detector (not shown) may be used to detect the medium M, which is about to enter a transporting passage and reach a working region (detection region) of the light emitting element 10 and the light-receiving element 30, and the light emitting element 10 and the light-receiving element 30 are enabled at a predetermined time. First, the processor 80 controls the reset circuit 70 to output a high-level pulse (continuously for about 1 millisecond (ms)) according to a maximum clearing signal MHC in the period from time instants t1 to t2. Then, the processor 80 controls the constant-current control circuit 20 to drive the light emitting element 10 to emit light continuously for the irradiation time T1 (e.g., 100 to 200 μs) in the period from time instants t3 to t4 according to a power control signal IPC, and then turns off the constant-current control circuit 20 to disable the light emitting element 10 from emitting light. At this time, an output signal SO of the light-receiving element 30 gradually rises in the period from the time instants t3 to t4, and then gradually falls in the period from time instants t4 to t5. A level of a maximum holding signal MH of the maximum holding circuit 50 also gradually rises to a maximum in the period from the time instants t3 to t4, and is then held at the maximum. The processor 80 reads the maximum of the maximum holding signal MH through the analog-to-digital converter circuit 60 at the time instant t5. Multiple points of measurement results can be obtained to prevent the local differences of the medium from affecting the detection result. For example, after the processor 80 has finished a first detection at a first time (time instant t5), a second detection starts at a time instant t6, and another maximum of the maximum holding signal MH is read by the analog-to-digital converter circuit 60 at a time instant t7, so that a second detection result is obtained. Similar processes can be repeated to obtain multiple points (e.g., ten points) of detection results. In one example, an average of the points of detection results serves as an overall detection result. Of course, the average may be obtained with one or multiple ones of the detection values with the significant deviation, but this disclosure is not restricted thereto. Therefore, the delaying module 84 of the processor 80 delays a period of time (e.g., the measurement cycle is 50 ms) after the operation (c), and then the repeating module 85 controls the resetting module 81, the holding module 82 and the reader module 83 to repeat the operations (a) to (c) to obtain another digital signal SD, so that the determining module 86 of the processor 80 can determine the thickness of the medium M according to the digital signals SD, and thus obtain a stabler result.

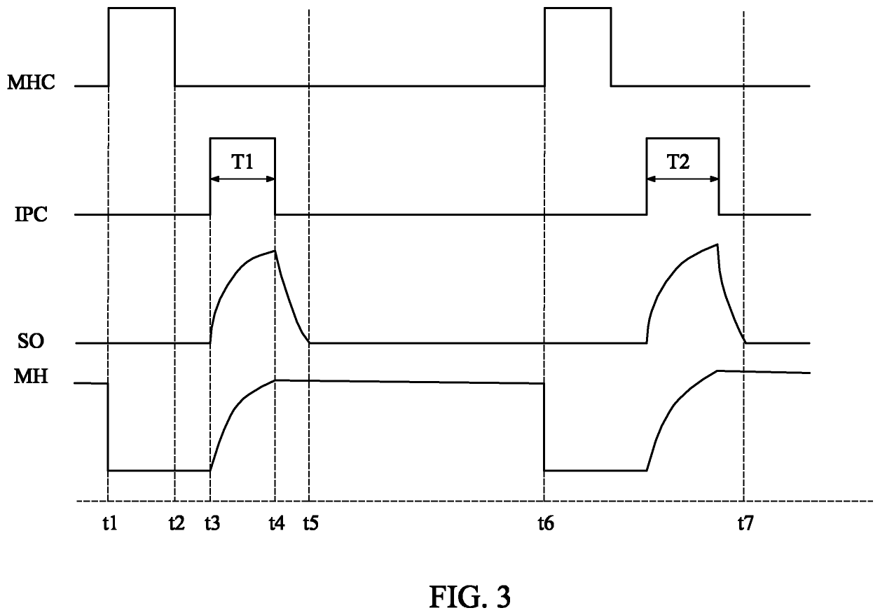

FIG. 3 shows an operation timing chart of the medium thickness detection device of FIG. 1 in a learning mode. Referring to FIGS. 1 and 3, when the specification of the medium M is known in the learning mode, a paper sheet having the basic weight of 70 GSM (Grams per Square Meter) or a light-shielding sheet having a transmission rate equal to that of the paper sheet having the basic weight of 70 GSM may be placed on an optical path between the light emitting element 10 and the light-receiving element 30, and a light-receiving operation is performed. The learning module 87 of the processor 80 adjusts the irradiation time T1 to a setting time according to the digital signal SD, and stores the setting time to a storage 90 of the medium thickness detection device 100. When the actual product is being produced or maintained, the selecting module 88 is artificially or automatically triggered to select to let the processor 80 firstly enter the learning mode to obtain the setting time, and then enter the detecting mode to read the setting time from the storage 90 as the irradiation time T1.

In the learning mode, the processor 80 performs the following operations in order. The resetting module performs the operation (a) of controlling the reset circuit 70 to reset the maximum holding circuit 50. The holding module performs the operation (b) of turning on the constant-current control circuit 20 to control the light emitting element 10 to output the light L continuously for the irradiation time T1, and then turning off the light emitting element 10 to let the maximum holding circuit 50 hold the maximum VM of the analog signal SA, and let the analog-to-digital converter circuit 60 generate the digital signal SD. The reader module 83 performs the operation (c) of reading the digital signal SD through the analog-to-digital converter circuit 60. The repeating module 85 performs the operation (d) of judging whether the digital signal SD falls within a predetermined level range. If the digital signal SD falls within the predetermined level range, then the irradiation time T1 serves as the setting time. If the digital signal SD does not fall within the predetermined level range, then the irradiation time T1 is changed (lengthened or shortened) to an irradiation time T2, and the operations (a) to (d) are repeated.

In one example, the paper sheet having the basic weight of 70 GSM is used as the medium M, and the setting module 89 sets the irradiation time T1, corresponding to a digital value (1024×2/3.3=621 corresponding to 2.0 volts for a 10-bit ADC) of the digital signal SD corresponding to the maximum VM substantially equal to 2.0 volts, as the setting time when a crossover voltage of the light-receiving element 30 is equal to 3.3 volts. According to the setting time, the digital signal SD being measured in the detecting mode and smaller than or equal to 2.2 volts is representative of the medium M having the thickness corresponding to that of the thickness of the paper sheet having the basic weight of 70 GSM or more, and the digital signal SD being measured in the detecting mode and greater than 2.2 volts is representative of the medium M having the thickness corresponding to that of the thickness of the paper sheet having the basic weight of 60 GSM or less.

Referring again to FIG. 1, the medium thickness detection device 100 may further include a light-guiding element 95 disposed on a first side (one side) of the medium M, wherein the light emitting element 10 and the light-receiving element 30 are disposed on a second side (the other side) of the medium M. The light-guiding element 95 guides the light L, so that the light L coming from the light emitting element 10 passes through the medium M twice and then enters the light-receiving element 30 to amplify the light shielding property of the medium M and obtain the more precise result. The light-guiding element 95 has an inlet 96 and an outlet 97, the light L penetrates through the medium M from the light emitting element 10 and enters the inlet 96, is then outputted from the outlet 97, then penetrates through the medium M, and then enters the light-receiving element 30. It is understandable that the light-guiding element 95 is not an essential element for implementing the embodiment of this disclosure because the light emitting element 10 and the light-receiving element 30 may also be disposed on two sides of the medium M, and the direct detection can be performed.

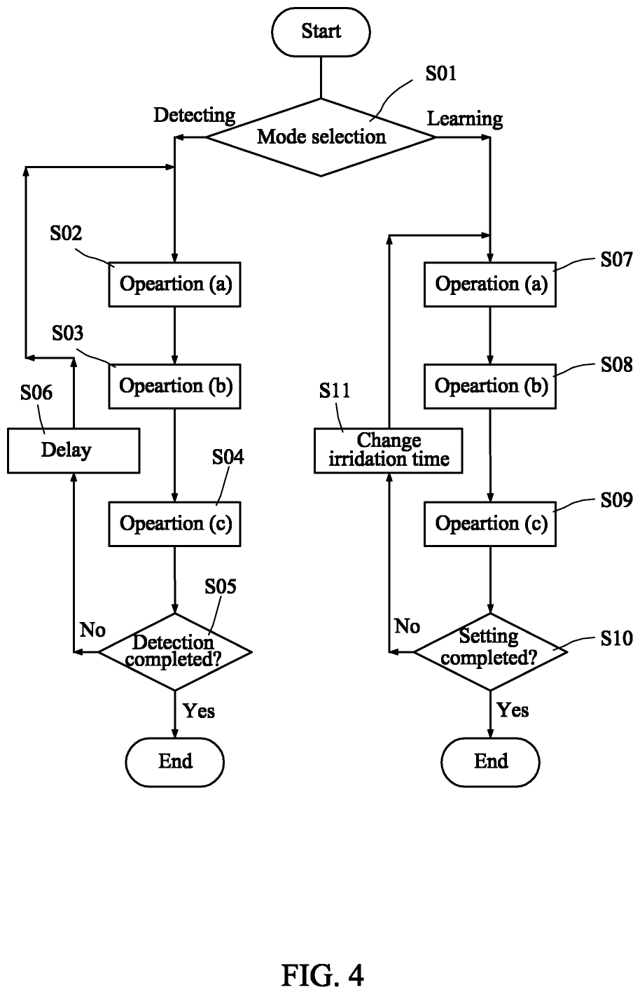

FIG. 4 shows an operation flow chart of the medium thickness detection device of FIG. 1. As shown in FIG. 4, steps S01 to S11 are performed. First, in the step S01, a mode selection process is entered to provide a selection interface, a switch, and the like to be selected by the user. In another example, an automatic selection may be performed when no learned setting time is present, and the learning mode is automatically entered. Then, when the detecting mode is selected, the operation (a) is performed in the step S02, then the operation (b) is performed in the step S03, then the operation (c) is performed in the step S04, and then it is judged whether the detection is completed (e.g., whether the detection fails, whether the data within the predetermined range is obtained, and the like) in the step S05. If the detection is completed, then the detection ends. If the detection is not completed, then the step S06 is entered to delay a period of time. Next, the process returns to the step S02 in a repeated manner until the detection ends. When the learning mode is selected, the operation (a) is performed in the step S07, then the operation (b) is performed in the step S08, then the operation (c) is performed in the step S09, and then it is judged whether the setting is completed (e.g., whether the setting fails, whether the data within the predetermined range is obtained, and the like) in the step S10. For example, the operation (d) is performed to judge whether the digital signal SD falls within a predetermined level range. If the setting is completed, then the setting ends. If the setting is not completed, then the step S11 is entered to change the irradiation time. Then, the process returns to the step S07 in a repeated manner until the setting ends.

In another embodiment, when the medium M is a simplex-side recycled waste paper, the light may be blocked or shielded by the toner or ink on the waste paper, so the multi-point detection can be performed, and the digital signal SD with the higher or highest level within a period of time is taken as the thickness determining basis to enhance the thickness determination precision and stability.

With the above-mentioned embodiment, the medium thickness detection device can provide the stable and precise detection result. Furthermore, the error problem caused by the detection result due to the process variability of the light-receiving element of the photo sensor, for example, can be decreased by the learning mode. Also, the self-learning thickness detection calibration can be achieved for the factory calibration or future maintenance calibration. The precise detection result can be used to control the printing or other processing parameters (e.g., medium transporting speed, fixation power, ink-jet flow, ink-jet processing temperature and the like) more precisely, and enhance the printing or other effects.

The specific embodiments proposed in the detailed description of this disclosure are only used to facilitate the description of the technical contents of this disclosure, and do not narrowly limit this disclosure to the above-mentioned embodiments. Various changes of implementations made without departing from the spirit of this disclosure and the scope of the claims are deemed as falling within the following claims.

1. A medium thickness detection device, comprising:
a light emitting element;
a constant-current control circuit, which is electrically connected to the light emitting element, and controls, in a constant-current manner, the light emitting element to output light passing through a medium for an irradiation time;
a light-receiving element receiving the light passing through the medium to obtain an analog signal;
a receiver circuit being electrically connected to the light-receiving element and receiving the analog signal;
a maximum holding circuit electrically connected to the receiver circuit, and holding a maximum of the analog signal;
an analog-to-digital converter circuit, which is electrically connected to the maximum holding circuit, reads the maximum of the analog signal, and converts the maximum of the analog signal into a digital signal;
a reset circuit being electrically connected to the maximum holding circuit and resetting the maximum holding circuit; and
a processor, which is electrically connected to the constant-current control circuit, the reset circuit and the analog-to-digital converter circuit, and controls operations of the constant-current control circuit, the reset circuit and the analog-to-digital converter circuit, wherein the processor determines a thickness of the medium according to the digital signal when a specification of the medium is unknown.

2. The medium thickness detection device according to claim 1, wherein the processor comprises a resetting module, a holding module and a reader module, wherein:
the resetting module performs an operation (a) of controlling the reset circuit to reset the maximum holding circuit;
the holding module performs an operation (b) of turning on the constant-current control circuit to control the light emitting element to output the light continuously for the irradiation time, and then turning off the light emitting element to let the maximum holding circuit hold the maximum of the analog signal, and let the analog-to-digital converter circuit generate the digital signal; and
the reader module performs an operation (c) of reading the digital signal through the analog-to-digital converter circuit.

3. The medium thickness detection device according to claim 2, wherein the processor further comprises a delaying module for delaying a period of time after the operation (c); and a repeating module of controlling the resetting module, the holding module and the reader module to repeat the operations (a) to (c) to obtain another digital signal.

4. The medium thickness detection device according to claim 3, wherein the processor further comprises a determining module of determining the thickness of the medium according to the digital signals.

5. The medium thickness detection device according to claim 1, wherein the processor comprises a determining module and a learning module, and has a detecting mode and a learning mode, wherein in the detecting mode, the determining module determines the thickness of the medium according to the digital signal, wherein in the learning mode, the learning module adjusts the irradiation time to a setting time according to the digital signal and stores the setting time to a storage when the specification of the medium is known.

6. The medium thickness detection device according to claim 5, wherein the processor further comprises a selecting module, which selects to make the processor firstly enter the learning mode to obtain the setting time, and then selects to make the processor enter the detecting mode to read, from the storage, the setting time as the irradiation time.

7. The medium thickness detection device according to claim 5, wherein the processor further comprises a resetting module, a holding module, a reader module and a repeating module, wherein in the learning mode:
the resetting module performs an operation (a) of controlling the reset circuit to reset the maximum holding circuit;
the holding module performs an operation (b) of turning on the constant-current control circuit to control the light emitting element to output the light continuously for the irradiation time, and then turning off the light emitting element to let the maximum holding circuit hold the maximum of the analog signal, and let the analog-to-digital converter circuit generate the digital signal;
the reader module performs an operation (c) of reading the digital signal through the analog-to-digital converter circuit; and
the repeating module performs an operation (d) of judging whether the digital signal falls within a predetermined level range, wherein: the irradiation time serves as the setting time if the digital signal falls within the predetermined level range; and the irradiation time is changed if the digital signal does not fall within the predetermined level range, and the operations (a) to (d) are repeated.

8. The medium thickness detection device according to claim 7, wherein the processor further comprises a setting module for setting the irradiation time, corresponding to the maximum substantially equal to 2.0 volts, as the setting time when a crossover voltage of the light-receiving element is equal to 3.3 volts.

9. The medium thickness detection device according to claim 1, further comprising a light-guiding element disposed on a first side of the medium, wherein the light emitting element and the light-receiving element are disposed on a second side of the medium, and the light-guiding element guides the light, so that the light coming from the light emitting element passes through the medium twice and then enters the light-receiving element to amplify a light shielding property of the medium.

10. The medium thickness detection device according to claim 9, wherein the light-guiding element has an inlet and an outlet, the light penetrates through the medium from the light emitting element and enters the inlet, is then outputted from the outlet, then penetrates through the medium, and then enters the light-receiving element.
